(19) United States
(12) Patent Application Publication
(10) Pub. No.: US 2018/0032822 A1
(43) Pub. Date: Feb. 1, 2018

(54) VEHICLE EXTERIOR MONITORING

(71) Applicant: Ford Global Technologies, LLC, Dearborn, MI (US)

(72) Inventors: Steven Frank, Dearborn, MI (US); Steve William Gallagher, Bloomfield Hills, MI (US); Bruno M. Barthelemy, Ann Arbor, MI (US)

(73) Assignee: Ford Global Technologies, LLC, Dearborn, MI (US)

(21) Appl. No.: 15/225,040

(22) Filed: Aug. 1, 2016

(51) Int. Cl. G06K 9/00; B60R 1/12; H04N 13/02

(52) U.S. Cl. CPC G06K 9/00791; H04N 13/02; B60R 1/12; B60R 2001/1253

(57) ABSTRACT

A vehicle assembly includes a side view mirror housing mountable to a vehicle exterior. A first LIDAR sensor is disposed in the side view mirror housing, has a first field of view, and is pointed in a first direction. A second LIDAR sensor is disposed in the side view mirror housing, has a second field of view, and is pointed in a second direction opposite the first direction. A camera is also disposed in the side view mirror housing, and the camera is spaced from the second LIDAR sensor. The camera has a third field of view and is pointed in the second direction.

### BACKGROUND

Autonomous vehicles depend on various sensors to monitor and provide information about objects in an area surrounding the vehicle. The sensors help the autonomous vehicle identify other vehicles, pedestrians, traffic signals, etc. Further, autonomous vehicles that can be manually operated (i.e., in a non-autonomous mode) still have more traditional vehicle components such as a steering wheel, side view mirrors, rear view mirrors, etc.

### BRIEF DESCRIPTION OF THE DRAWINGS

FIG. 1 illustrates an example vehicle with side view mirror housings having LIDAR sensors and a camera.

FIG. 2A illustrates a perspective of an example side view mirror housing of the vehicle of FIG. 1.

FIG. 2B illustrates another perspective view of the example side view mirror housing of FIG. 2A.

FIG. 3 illustrates examples components of a vehicle assembly incorporated in the vehicle of FIG. 1.

FIG. 4 is an example process that may be executed by a processor in the vehicle assembly.

FIG. 5 is another process that may be executed by a processor in the vehicle.

### DETAILED DESCRIPTION

Autonomous vehicles do not need many of the components traditionally found in non-autonomous vehicles. For instance, fully autonomous vehicles do not need a steering wheel, side view mirrors, a rear view mirror, an accelerator pedal, a brake pedal, etc. Many of those components are incorporated into autonomous vehicles in case the owner wishes to manually operate the vehicle, leaving little room for autonomous vehicle sensors. Thus, integrating autonomous vehicle sensors into existing vehicle platforms can prove challenging. For example, trying to place additional sensors onto existing vehicle platforms may be problematic. Placing a LIDAR sensor on the vehicle roof could increase aerodynamic resistance, resulting in increased noise, reduced fuel efficiency, etc. Additionally, placing LIDAR sensors on top of the vehicle roof could make the vehicle too tall to fit in, e.g., the owner's garage. While placing autonomous vehicle sensors on the pillars of the vehicle body may avoid the issues with placing the sensors on the vehicle roof, doing so may require extensive and costly structural changes to the vehicle body.

Rather than completely redesign the vehicle platform to accommodate autonomous driving sensors, the sensors can be embedded in the side view mirror housing. Thus, one solution includes a side view mirror housing mountable to a vehicle exterior. A first LIDAR sensor is disposed in the side view mirror housing, has a first field of view, and is pointed in a first direction. A second LIDAR sensor is disposed in the side view mirror housing, has a second field of view, and is pointed in a second direction opposite the first direction. A camera is also disposed in the side view mirror housing, and the camera is spaced from the second LIDAR sensor. The camera has another field of view and is also pointed in the second direction.

From their location in the side view mirror housing, the LIDAR sensors may provide data about the area surrounding the vehicle. And because side view mirror assemblies are already designed for aerodynamic performance, incorporating the LIDAR sensors into the side view mirror housing will not increase the aerodynamic resistance relative to non-autonomous vehicles. Further, the image data captured by the camera can be transmitted to a display screen inside the vehicle. Therefore, with the camera, the mirrors can be omitted from the side view mirror housing, and a human operator will still be able to see in the blind spot of the vehicle despite there being no mirrors.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

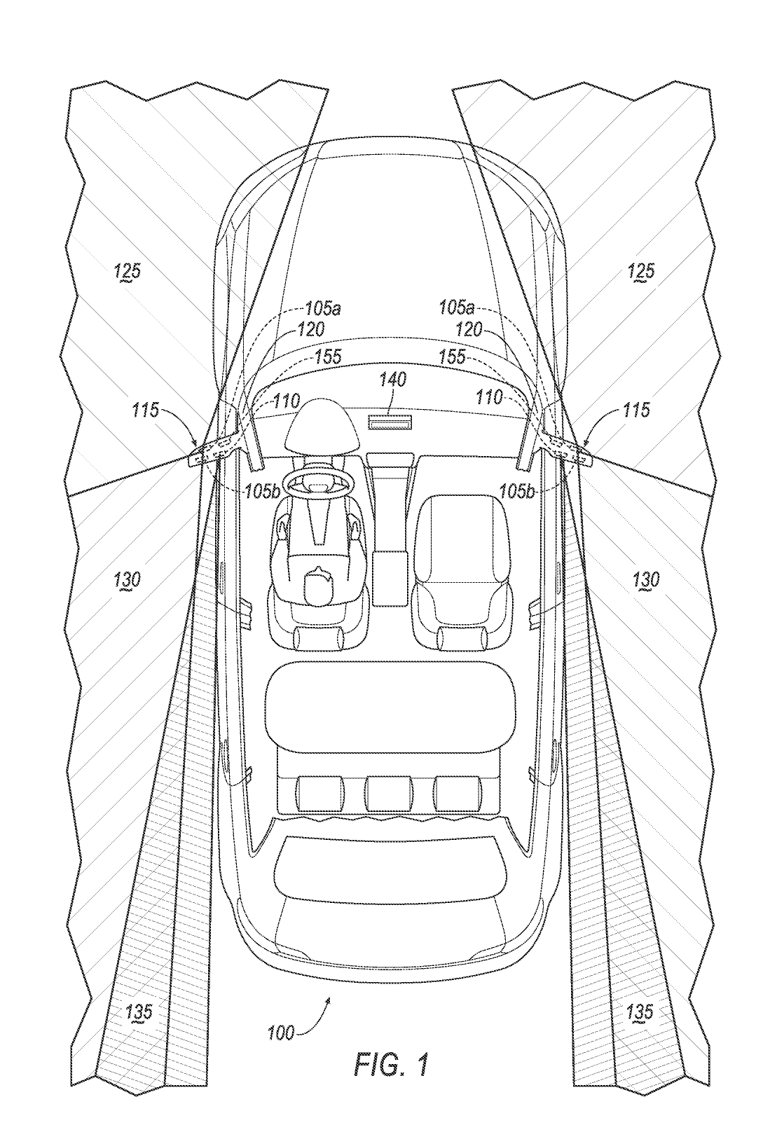

FIG. 1 illustrates a vehicle 100 with multiple LIDAR sensors 105 and at least one camera 110 incorporated into the side view mirror housing 115. Although illustrated as a sedan, the vehicle 100 may include any passenger or commercial automobile such as a car, a truck, a sport utility vehicle, a crossover vehicle, a van, a minivan, a taxi, a bus, etc. In some possible approaches, the vehicle 100 is an autonomous vehicle that operates in an autonomous (e.g., driverless) mode, a partially autonomous mode, and/or a non-autonomous mode.

The side view mirror housing 115 is mountable to a vehicle exterior 120. A first LIDAR sensor 105a is disposed in the side view mirror housing 115 and has a first field of view 125 and pointed in a first direction. A second LIDAR sensor 105b is also disposed in the side view mirror housing 115. The second LIDAR sensor 105b has a second field of view 130 and pointed in a second direction opposite the first direction. Further, a camera 110 is disposed in the side view mirror housing 115. The camera 110 is spaced from the second LIDAR sensor 105b and the camera 110 having a third field of view 135 and pointed in the second direction.

As one example, the first direction is at least partially toward a forward direction (i.e., front-facing) of the vehicle 100, the second direction is at least partially toward a rear direction (i.e., rear-facing) of the vehicle 100, and the first and second field of views 125, 130 do not overlap. The third field of view 135 overlaps with the second field of view 130 of the second LIDAR sensor 105b. Alternatively, the first and second field of views 125, 130 may overlap.

Because the LIDAR sensors 105 can be incorporated into the side view mirror housing 115, the mirror found in a traditional side view mirror may be eliminated. The image data captured by the camera 110 can be presented on a display screen 140 inside the vehicle 100 or incorporated into the side view mirror housing 115 to allow human operator to see in the blind spot of the vehicle 100.

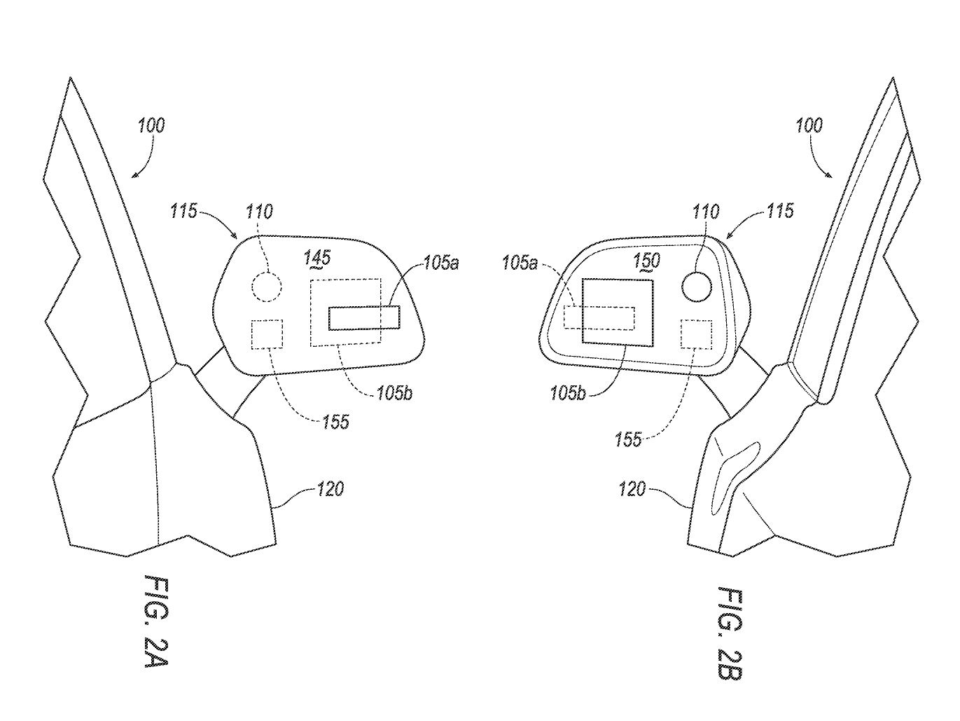

FIG. 2A-2B illustrate a side view mirror housing 115 mounted to the vehicle 100. Although only one side view mirror housing 115 is shown, additional side view mirror housing 115s can be mounted to the vehicle 100 (e.g., on the opposite side of the vehicle 100). FIG. 2A is a front view of the side view mirror housing 115. As shown in FIG. 2A, the first LIDAR sensor 105a is disposed in the side view mirror housing 115 and faces the direction of forward travel of the vehicle 100. FIG. 2B illustrates the second LIDAR sensor 105b and the camera 110 disposed in the side view mirror housing 115. Both the second LIDAR sensor 105b and the camera 110 may face the direction of rearward travel of the vehicle 100.

As shown in FIGS. 2A and 2B, the side view mirror housing 115 may include a first exterior surface 145 (e.g., front-facing side) and a second exterior surface 150 (e.g., rear-facing side). As one example, the first LIDAR sensor 105a may be flush with the first exterior surface 145 to reduce aerodynamic resistance of the side view mirror housing 115 or for aesthetic purposes. The camera 110, the second LIDAR sensor 105b, or both, may be flush with the second exterior surface 150, again to reduce aerodynamic resistance or for aesthetic purposes.

The field of view of the camera 110 (i.e., the third field of view 135) may be adjustable relative to the side view mirror housing 115. For example, a camera actuator 155, which may include a step motor, a linear actuator, or the like, is disposed in the side view mirror housing 115 may move the camera 110 toward and away from the second exterior surface 150 to adjust the third field of view 135. Other ways to adjust the third field of view 135 may include pivoting the camera 110 relative to the side view mirror housing 115, moving a lens of the camera 110 relative to an imager sensor of the camera 110 (i.e., adjusting a focal point), etc. Thus, adjusting the third field of view 135 may change the image data presented on the display screen 140 inside the vehicle 100 to the human operator. The first and second fields of view 125, 130 of the first and second LIDAR sensors 105a,105b may be independent of third field of view 135 adjustments. That is, adjusting the third field of view 135 may not change the first field of view 125, the second field of view 130, or both.

The adjustments to the third field of view 135 may be initiated by a user input. For example, the user input may be received in response to the user pressing a button, in the passenger compartment, that sends a camera field of view adjustment request to move the camera 110, e.g., change a position of the camera relative to the side view mirror housing. The user can see a substantially real-time image on the display screen 140, i.e., an image displayed on the display screen 140 may have been captured by the camera 110 in less than 200 ms prior to being displayed, so the user knows when to stop adjusting the third field of view 135.

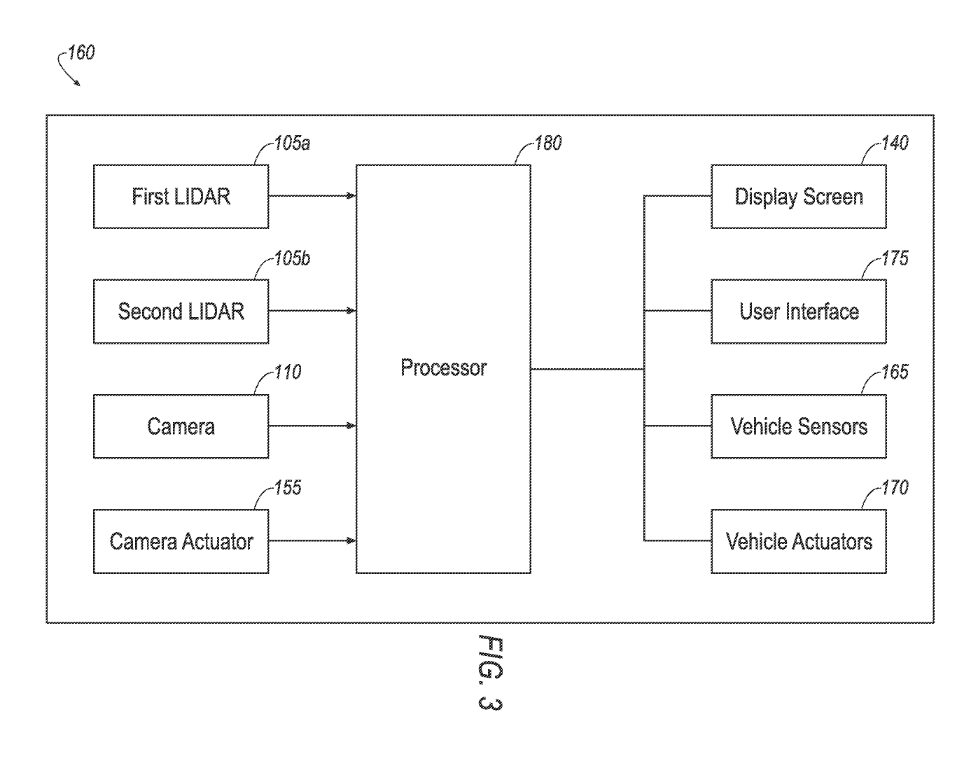

Referring now to FIG. 3, a vehicle assembly 160 incorporated into the vehicle 100 may include vehicle sensors 165, vehicle actuators 170, the display screen 140, a user interface 175, the camera 110, the camera actuator 155, the first and the second LIDAR sensors 105a, 105b, and a processor 180.

The vehicle sensors 165 are implemented via circuits, chips, or other electronic components that can collect data and output signals representing the data collected. Examples of vehicle sensors 165 may include an engine sensor such as a mass airflow sensor or climate control sensors such as an interior temperature sensor. The vehicle sensors 165 may output signals to various components of the vehicle 100, such as the processor 180.

The vehicle actuators 170 are implemented via circuits, chips, or other electronic components that can actuate various vehicle subsystems in accordance with appropriate control signals. For instance, the vehicle actuators 170 may be implemented via one or more relays, servomotors, etc. The vehicle actuators 170, therefore, may be used to control braking, acceleration, and steering of the vehicle 100. The control signals used to control the vehicle actuators 170 may be generated by various components of the vehicle 100, such as the processor 180.

The display screen 140 may be incorporated into an interior rear view mirror, a display unit included in an electronic instrument cluster, the side view mirror housing 115, or any other display unit associated with the vehicle 100. The display screen 140 may receive image data captured by the camera 110 and present an image, associated with the received image data, on the display screen 140. The presented image on the display screen 140 may be adjustable. For instance, the view may be adjusted via a user input, e.g., the camera field of view adjustment request. Alternatively or additionally, the user input may include a selection of a region of interest in the image. In response to that user input, the display screen 140 may be programmed to adjust the output of the image to present only a portion of the image data received from the camera 110. For example, the third field of view 135 of the camera 110 may include a wide view of the area surrounding the vehicle 100 and the user input may designate only a blind spot area to be shown on the display. In response, the display screen 140 may output only the blind spot area as opposed to the entire image represented by the image data.

The camera 110 may include a housing, a lens, a circuit board, and an imaging sensor. The lens may include a transparent substrate that directs light toward the image sensor, and is mounted to the housing. The circuit board may be mounted inside the housing. The circuit board receives the captured image signals from the imaging sensor and sends signals relating to images received to one or more other components of the vehicle 100 system such as the display screen 140. The circuit board may include an interface such as Ethernet or low-voltage differential signaling (LVDS) for transmitting the image data. The imaging sensor may be mounted directly to the circuit board, and may be located where it can capture light that travels through the lens. A principal axis of the lens may be substantially perpendicular to the imaging sensor surface. In order to change the third field of view 135 of the camera 110, a direction of the principal axis of the lens may be changed, as discussed below. As another example, the lens may be movable relative to the imaging sensor, and a focal point of the lens may be changed by moving the lens relative to the imaging sensor, as discussed below.

The camera actuator 155 includes components that convert electronic signals into mechanical motion, such as a motor or a linear actuator. The camera actuator 155 may be disposed inside the side view mirror housing 115 and at least partially supports the camera 110. The camera actuator 155 can be supported by the side view mirror housing 115, e.g., attached to an interior surface thereof. In one possible approach, the camera actuator 155 receives a signal from the input element, the display screen 140, or any other component of the vehicle 100 system, and changes the third field of view 135 of the camera 110 according to the received signal. In one example, the camera actuator 155 can change the third field of view 135 by moving the direction of the principal axis of the camera lens. As another example, the camera housing, the circuit board and the imaging sensor are fixed relative to one another and to the side view mirror housing 115, and the camera actuator 155 moves the camera lens relative to the imaging sensor, causing a focal point of the lens to change. Such changes of the focal point, may cause a change of the third field of view 135 such as narrowing or widening of the third field of view 135.

Each of the first and the second (Light Detection and Ranging) LIDAR sensors 105a, 105b may include a light transmitter and a light receiver. The light transmitter radiates laser light or a beam of light in other spectral regions like the near infrared region. Wavelengths transmitted by the light transmitter may vary to suit the application. For example, mid-infrared light beams may be more appropriate for automotive applications. The light receiver receives the reflection of the transmitted radiation to image objects and surfaces. Typically, a LIDAR sensor can provide data for mapping physical features of sensed objects with a very high resolution, and can target a wide range of materials, including non-metallic objects, rocks, rain drops, chemical compounds, etc.

The processor 180 is implemented via circuits, chips, or other electronic components that may be programmed to receive LIDAR sensor data representing the first and the second fields of view 125, 130 and create a three dimensional model of some or all of the first and second fields of view 125, 130. In other words, the processor 180 is programmed to identify objects located in the first and second fields of view 125, 130. For example, the three dimensional map of the area surrounding the vehicle 100 may include data indicating distance, size, height of nearby objects, which could include other vehicles, road structures, pedestrians, etc. A field of view of the three dimensional model may be defined by an area surrounding the vehicle 100 pertaining to both the first and second fields of view 125, 130. The field of view of the three dimensional model at least partially depends on the first field of view 125, the second field of view 130, and an extent of overlap between the first and second fields of view 125, 130. As one example, the field of view of the model may exceed 180 degrees, e.g., when a horizontal angle of view (i.e., an angle parallel to the ground surface) of the first or second field of view 125, 130 exceeds 90 degrees.

Further, the processor 180 may be programmed to combine data from the LIDAR sensors and other vehicle sensors 165 to output a three dimensional model of the area surrounding the vehicle 100. For example, the LIDAR sensor data can be combined with data from a camera behind the front windshield facing away from the vehicle 100 (i.e., toward a forward direction of travel), a rear camera mounted to a rear bumper facing away from the vehicle 100 (i.e., toward a rear direction of travel), etc. This or other data fusion techniques can improve object detection and confidence in the produced data.

Using data received from vehicle sensors 165 and the three dimensional map of the area surrounding the vehicle 100 generated based on LIDAR sensors data, the processor 180 may operate the vehicle 100 in an autonomous mode. Operating the vehicle 100 in the autonomous mode may include making various determinations and controlling various vehicle components and operations that would traditionally be handled by a human driver. For instance, the processor 180 may be programmed to regulate vehicle operational behaviors such as speed, acceleration, deceleration, steering, etc., as well as tactical behaviors such as a distance between vehicles, lane-change minimum gap between vehicles, left-turn-across-path minimum, time-to-arrival at a particular location, intersection (without signal) minimum time-to-arrival to cross the intersection, etc. The processor 180 may be further programmed to facilitate certain semi-autonomous operations. Examples of semi-autonomous operations may include vehicle operations with some driver monitoring or engagement such as adaptive cruise control controls where the processor 180 controls the vehicle 100 speed and a human driver steers the vehicle 100.

The processor 180 may be further programmed to process certain user inputs received during autonomous, semi-autonomous, or non-autonomous operation of the vehicle 100. As one example, the user may view the image captured by the camera 110 on the display screen 140 when manually steering the vehicle 100 while the vehicle 100 is operating in the semi-autonomous or non-autonomous mode. For instance, the user may rely on the image to monitor a rear quarter blind spot. Further, the processor 180 may process user inputs adjusting the third field of view 135 of the camera 110 and output control signals to the camera actuator 155 or the display screen 140 to display the desired view of the area surrounding the vehicle 100.

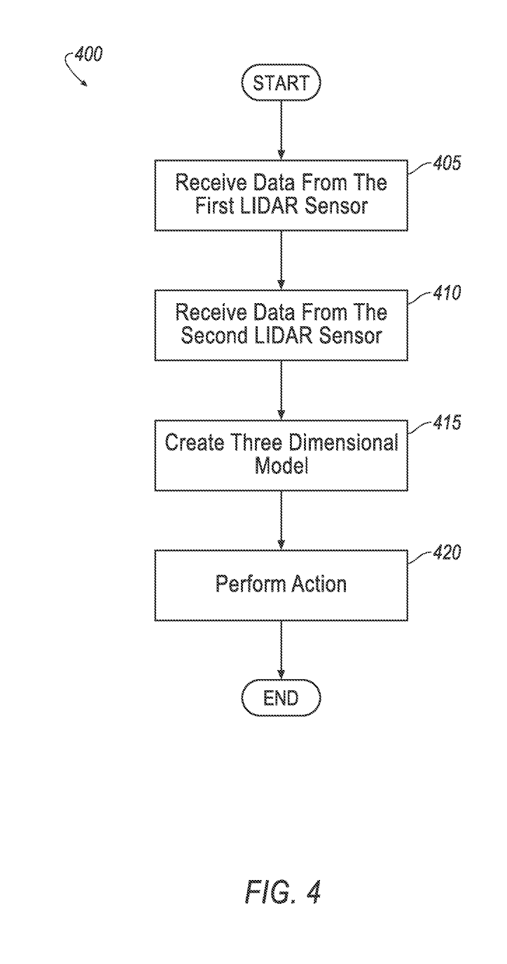

FIG. 4 is a flowchart of an example process 400 for operating the vehicle 100 in an autonomous or semi-autonomous mode. The process 400 may be executed by the processor 180. The process 400 may be initiated at any time while the processor 180 is operating (e.g., while the vehicle 100 is running). In some instances, the processor 180 may continue to operate until the vehicle 100 is turned off.

At block 405, the processor 180 receives data from the first LIDAR sensor 105a. As discussed above, the first LIDAR sensor 105a is located in a side view mirror housing 115. The data received from the first LIDAR sensor 105a may represent the first field of view 125 of an area surrounding the vehicle 100. The data may be received by the processor 180 via a vehicle communication network such as Ethernet.

At block 410, the processor 180 receives data from the second LIDAR sensor 105b. The data from the second LIDAR sensor 105b may represent the second field of view 130 and may be received via the vehicle 100 communication network such as Ethernet. In some possible approaches, the processor 180 may receive data from other LIDAR sensors in the vehicle 100 at block 405 or 410. For example, as shown in FIG. 1, the vehicle 100 may include another side view mirror housing 115 with two other LIDAR sensors 105. Thus, in this example, the processor 180 may receive additional data from a third and a fourth LIDAR sensors 105 located in a second side view mirror housing 115 located on another side of the vehicle 100.

At block 415, the processor 180 generates a three dimensional model of an area surrounding the vehicle 100 from the data received at blocks 405 and 410. The processor 180 may use data fusion techniques such as stitching to generate the three dimensional model when the received data is from more than one LIDAR sensors 105. The processor 180 may further execute machine vision algorithms to detect objects such as other vehicles, pedestrians, road signs, traffic control devices, etc., represented by the three dimensional model.

At block 420, the processor 180 performs an action based on the three dimensional model. Specifically, the processor 180 may perform an action in accordance with the objects detected at block 415. Performing an action may include the processor 180 determining whether to brake, accelerate, or steer the vehicle 100. Performing the action may further include the processor 180 sending control signals, via vehicle communication network, to various vehicle actuators 170 that can carry out the action. The process may end after block 420 or return to block 405 so additional sensor data may be considered.

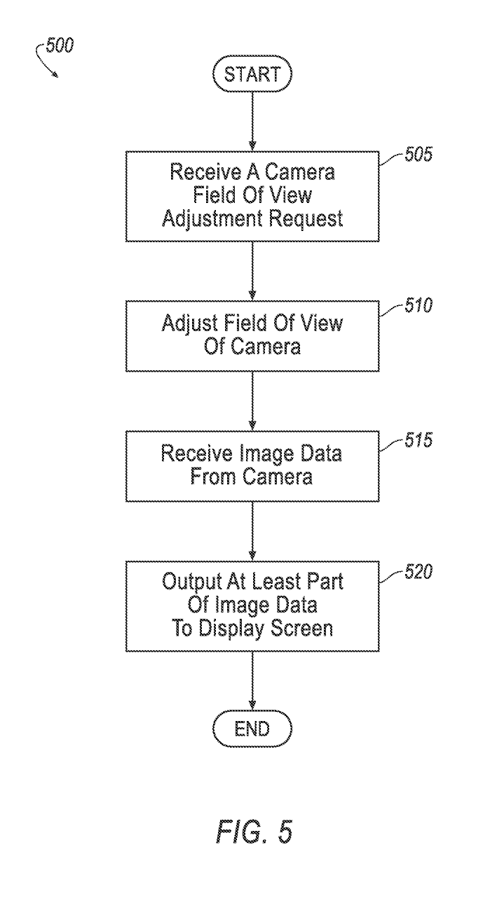

FIG. 5 is a flowchart of an example process 500 for operating the camera 110 with the third field of view 135 included in the side view mirror housing 115. The process 500 may be executed by the processor 180. The process 500 may be initiated at any time while the processor 180 is operating, such as while the vehicle 100 is running. The processor 180 may continue to operate until, e.g., the vehicle 100 is turned off.

At block 505, the processor 180 receives a camera field of view adjustment request from the user interface 175, display screen 140, etc. For example, the camera field adjustment request may include various discrete signal values such as move up, move down, turn right, turn left, stop. The request may be received via the vehicle communication network.

At block 510, the processor 180 may send a signal to the camera actuator 155 based on the received camera field of view adjustment request. For example, the camera actuator 155 may have four wires connected to the processor 180. Each wire may be dedicated to a specific movement direction, e.g., a “right”, “left”, ‘up’, and “down” for moving to a right, left, up, and down direction respectively. When the processor 180 transmits a signal to move up the third field of view 135 of the camera 110, the processor 180 may send an ON signal on the “up” wire while sending OFF signals on “right”, “left”, and “down” wires. Alternatively, the camera actuator 155 may be a linearly displacing actuator for a focal length adjustment as discussed with respect to FIG. 3. The processor 180 may send a forward, backward, and stop signal to the linearly displacing camera actuator 155 to adjust the third field of view 135 of the camera 110.

At block 515, the processor 180 receives image data from the camera 110. The image data may be received via the vehicle 100 communication bus. For instance, the image data may be received in accordance with an Ethernet or a dedicated low-voltage differential signaling (LVDS) interface.

At block 520, the processor 180 outputs at least part of the image data, received from the camera 110, to the display screen 140. The image data may be presented in accordance with the received image data and an adjustment in the display screen 140. The adjustment may be made in accordance with a user input. For example, the processor 180 may cut out a part of the received image so that only a subset of the image is displayed on the display screen 140. The process 500 may end after block 520 or may return to block 505 so that additional camera data may be received and processed.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A vehicle assembly comprising:
a side view mirror housing mountable to a vehicle exterior;
a first LIDAR sensor disposed in the side view mirror housing, the first LIDAR sensor having a first field of view and pointed in a first direction;
a second LIDAR sensor disposed in the side view mirror housing, the second LIDAR sensor having a second field of view and pointed in a second direction opposite the first direction; and
a camera disposed in the side view mirror housing, spaced from the second LIDAR sensor, the camera having a third field of view and pointed in the second direction.

2. The vehicle assembly of claim 1, wherein the side view mirror housing includes a front-facing side and a rear-facing side and wherein the first LIDAR sensor is disposed on the front-facing side and wherein the second LIDAR sensor and the camera are disposed on the rear-facing side.

3. The vehicle assembly of claim 1, wherein the third field of view of the camera at least partially overlaps the second field of view of the second LIDAR sensor and does not overlap the first field of view of the first LIDAR sensor.

4. The vehicle assembly of claim 1, further comprising a display screen and a processor programmed to receive image data from the camera and output at least part of the received image data to the display screen.

5. The vehicle assembly of claim 1, wherein the third field of view of the camera is adjustable relative to the side view mirror housing.

6. The vehicle assembly of claim 5 further comprising a processor programmed to receive a field of view adjustment request and adjust the third field of view according to the received field of view adjustment request.

7. The vehicle assembly of claim 6, wherein adjusting the third field of view according to the received adjustment request includes adjusting a position of the camera relative to the side view mirror housing.

8. The vehicle assembly of claim 7, wherein adjusting the position of the camera relative to the side view mirror housing includes linearly moving the camera in one of the first direction and the second direction.

9. The vehicle assembly of claim 6, wherein the first LIDAR sensor and the second LIDAR sensor are fixed relative to the side view mirror housing.

10. The vehicle assembly of claim 1, further comprising a processor programmed to:
receive data from the first and the second LIDAR sensors; and
create a three dimensional model of an area surrounding the side view mirror housing in accordance with the first field of view and the second field of view.

11. The vehicle assembly of claim 1, wherein the side view mirror housing further includes at least one exterior surface, and wherein at least one of the first LIDAR sensor, the second LIDAR sensor, and the camera is flush with the at least one exterior surface of the side view mirror housing.

12. A method, comprising:
receiving data from a first LIDAR sensor disposed in a side view mirror housing of an autonomous vehicle, the first LIDAR sensor having a first field of view and pointed in a first direction;
receiving data from a second LIDAR sensor disposed in the side view mirror housing, the second LIDAR sensor having a second field of view and pointed in a second direction opposite the first direction;
generating a three dimensional model of an area surrounding the side view mirror housing in accordance with the first field of view and the second field of view; and
controlling the autonomous vehicle according to the three dimensional model generated.

13. The method of claim 12, wherein the three dimensional model has an angle of view greater than 180 degrees.

14. The method of claim 12, wherein the first field of view and the second field of view overlap.

15. The method of claim 12, further comprising:
receiving a field of view adjustment request; and
adjusting a third field of view of a camera disposed in the side view mirror housing in accordance with the received field of view adjustment request.

16. The method of claim 15, wherein adjusting the third field of view of the camera includes outputting a signal to a camera actuator.

17. The method of claim 15, further comprising:
receiving image data from the camera; and
outputting at least part of the received image data to a display screen located in the autonomous vehicle.

18. A vehicle assembly comprising:
a side view mirror housing mountable to a vehicle exterior;
a first LIDAR sensor disposed in the side view mirror housing, the first LIDAR sensor having a first field of view and pointed in a first direction;
a second LIDAR sensor disposed in the side view mirror housing, the second LIDAR sensor having a second field of view and pointed in a second direction opposite the first direction;
a camera disposed in the side view mirror housing, spaced from the second LIDAR sensor, the camera having a third field of view and pointed in the second direction
a display screen; and
a processor programmed to receive image data from the camera and output at least part of the received image data to the display screen, wherein the processor is programmed to:
receive data from the first and the second LIDAR sensors; and
create a three dimensional model of an area surrounding the side view mirror housing in accordance with the first field of view and the second field of view.

19. The vehicle assembly of claim 18, wherein the side view mirror housing includes a front-facing side and a rear-facing side and wherein the first LIDAR sensor is disposed on the front-facing side and wherein the second LIDAR sensor and the camera are disposed on the rear-facing side.

20. The vehicle assembly of claim 18, wherein the processor is further programmed to receive a field of view adjustment request and adjust the third field of view according to the received field of view adjustment request.
